(19) United States
(12) Patent Application Publication
(10) Pub. No.: US 2007/0146725 A1
(43) Pub. Date: Jun. 28, 2007

(54) METHOD OF AND DEVICE FOR THICKNESS MEASUREMENTS OF THIN FILMS

(76) Inventors: Michael Leonidovich Belov, Moscow (RU); Victor Aleksandrovich Gorodnichev, Moscow (RU); Valentin Ivanovich Kozintsev, Moscow (RU); Olga Alekseevna Smirnova, Moscow (RU); Yurii Victorovich Fedotov, Moscow (RU)

Correspondence Address: UNITED STATES DEPARTMENT OF ENERGY, 1000 INDEPENDENCE AVENUE, S.W., ATTN: GC-62 (HQ) MS 6F-067, WASHINGTON, DC, 20585-0162, US

(21) Appl. No.: 11/559,014

(22) Filed: Nov. 13, 2006

(30) Foreign Application Priority Data
Nov. 10, 2005 (RU) 2005134709

(51) Int. Cl. G01B 11/02; G01B 11/28

(52) U.S. Cl. 356/503; 356/630

(57) ABSTRACT

A method of measuring a thickness of thin films has the steps of irradiating a surface by an optical beam, receiving a reflected signal, analyzing a dependence of the reflected signal on a wavelength, determining a film thickness based on the analysis, and using for the irradiation three wavelengths which are close to each other, the determining including determining the film thickness based on the analysis of intensity of the reflected signal at the three wavelengths.

### CROSS-REFERENCE TO A RELATED APPLIACTION

The invention described and claimed hereinbelow is also described in Russian Patent Application No. 2005134709 filed on Nov. 10, 2005 This Russian Patent Application, whose subject matter is incorporated here by reference, provides the basis for a claim of priority of invention under 35 U.S.C 119(a)-(d).

### BACKGROUND OF THE INVENTION

The present invention relates to a remote method of thickness measurement of thin films on a substrate surface as well as to a device for implementing the inventive method.

Methods for film thickness measurements on a substrate are known. Such methods are disclosed for example in patent documents JP 3-57407, U.S. Pat. No. 4,645,439, RU 2,168,151, and RU 2,207,501. In the known methods the film surface is irradiated by optical beams, the reflected signal from the surface radiation is received, the dependence on the reflected signal intensity is measured as a function of wavelength, and the film thickness is determined by calculation results of distance between extremes, amount of extremes, or parameters of approximation of the dependence of the reflected signal intensity versus wavelength in a tuning range.

The disadvantage of the known methods is that it is necessary to carry out measurements in many spectral channels, i.e. measurements with which the source irradiates and the detector receives radiation in several tens of wavelengths.

### SUMMARY OF THE INVENTION

Accordingly, it is an object of the present invention to provide a method of and device for thickness measurements of thin films which avoids the disadvantages of the prior art.

In keeping with these objects and with others which will become apparent hereinafter, one feature of the present invention resides, briefly stated, in a method of measuring a thickness of thin films, comprising the steps of irradiating a surface by an optical beam; receiving a reflected signal, analyzing a dependence of the reflected signal on a wavelength; determining a film thickness based on the analysis; and using for the irradiation three wavelengths which are close to each other, said determining including determining the film thickness based on the analysis of intensity of the reflected signal at the three wavelengths.

In accordance with a further feature of the present invention, the step of using the three irradiated wavelengths which are located close to each other includes using the wavelengths selected so that the three wavelengths are as follows:
λ₁=λ₂−Δλ,λ₃=λ₂+Δλ,Δλ<<λ₂.

Another feature of the present invention resides, in a device for measuring a thickness of thin films, comprising means for irradiating a surface by an optical beam; means for receiving a reflected signal; means for analyzing a dependence of the reflected signal on a wavelength; means for determining a film thickness based on the analysis, wherein said means for irradiating a surface by an optical beam being configured so as to use for the irradiation three wavelengths which are close to each other, and said determining means being configured so that the film thickness is determined based on the analysis of intensity of the reflected signal on the three wavelengths.

The present invention can be used for on-line remote (airborne or shipborne) thickness measurement of thin films, for example thin petrochemical films in inland waters, harborage near-shore zones, etc., to control pollution level of water areas, to control unsanctioned waste disposal, etc. It can be used for non-contact thickness measurements of all kinds of films.

The novel features of which are considered as characteristic of the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a method of and device for thickness measurements of thin films, in accordance with the present invention; and

FIG. 2 is a diagram showing relationship between a given film thickness and a found film thickness.

### DESCRIPTION OF THE ED EMBODIMENTS

The method for a thickness measurement of thin films which is realized with a device for film thickness measurement in accordance with the present invention includes irradiation of surface by optical beam, reception of reflected signal, and analysis of dependence of reflected signal on wavelength, which defines film thickness.

In accordance with the present invention, for surface irradiation three wavelengths are used, which are located close to each other. Film thickness is determined using measurement results of reflected signal at these three wavelengths.

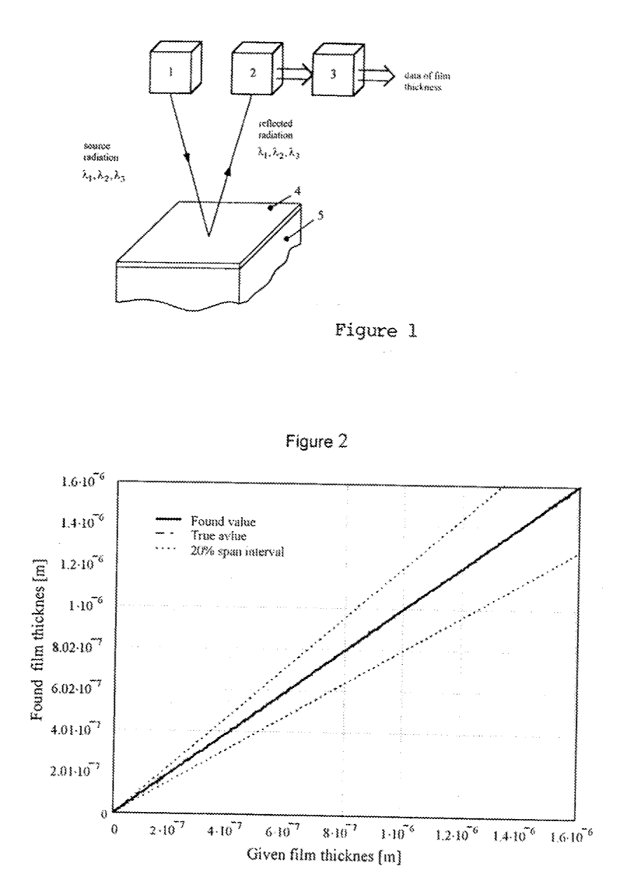

The proposed method can be realized using the device that is shown in FIG. 1. The device has a radiation source 1 which provides a surface radiation at three wavelengths disposed close to each other. The device further has a photodetector 2 for radiation registration at three wavelengths, It also has a processing unit 3 for thickness determination of a film 4 on a substrate surface 5 using measurement results of reflected signal.

The device operates in the following way.

Optical radiation of the source 1 at each wavelength λ₁, λ₂ and λ₃ is reflected from the film 4 surface (thickness d) and the substrate surface 5, the photodetector 2 registers intensity of reflected radiation, the signal from the detector 2 enters into the processing unit 3 for determination of film thickness d using measurement results.

The wavelengths λ₁, λ₂ and λ₃ are selected so that they are close to each other. In particular
λ₁=λ₂−Δλ,λ₃=λ₂+Δλ,Δλ<<λ₂.

The photodetector 2 receives radiation powers P(λ₁), P(λ₂) and P(λ₃) at three wavelengths. Each power P(λ₁), P(λ₂) and P(λ₃) can be represented in the following form (see e.g. Opto-Electronic Systems of Ecological Monitoring of Environment/V.I. Kozintsev, V. M. Orlov, M. L. Belov, et al,—Moscow: Publ. House of BMSTU, 2002-528 p):
P(λ)=AR_{ref}(λ,d)
where:
R_{ref}(λ,d) is the reflection coefficient of three layer system “air-petrochemical film-water” dependent on wavelength λ and on film thickness d;
“A” is the quantity dependent on parameters of radiation source and photodetector, on distance to the surface, on sea surface roughness (at sounding of rough sea surface for example). The quantity A is slowly changing (in comparison to R_{ref}(λ,d) with change of radiation wavelength. If the wavelength λ₁ and λ₂ are close to each other, then
   A(\hat{λ}₁)≅A(\hat{λ}₂).

The quantity A is not known for certain and is often a random quantity. For example, the number of reflecting elements in field of view of detector and their slopes are a random quantity at sounding of rough sea surface.

In the processing unit 3, the following procedures are conducted for elimination of influence of random variations of powers of laser sources and of indetermination of quantity A on measurement results:

the powers P(λ₁), P(λ₂) and P(λ₃) are normalized by output powers Pₛ(λ₁), Pₛ(λ₂) and (λ₃) radiated by a lidar at the wavelengths λ₁, λ₂ and λ₃:

$$\tilde{P} ( {λ}_{1 , 2 , 3} ) = \frac{P ( {λ}_{1 , 2 , 3 )}}{{P}_{s} ( {λ}_{1 , 2 , 3 )}}$$

the following relative quantities are calculated

$${B}_{1} = \frac{\tilde{P} λ {(}_{1} )}{\tilde{P} ( {λ}_{2} )} \qquad and \qquad {B}_{3} = \frac{\tilde{P} ( {λ}_{3} )}{\tilde{P} ( {λ}_{2} )} .$$

For the method simplification it is accepted that pulse length and divergence of the lidar are equal at all wavelengths. If this is not the case then differences can be taken into account by processing of received signals.

After the described procedures the quantity B₁ and B₃ are presented with fine precision ratio of reflection of surface at wavelengths λ₁, λ₃ and λ₂, λ₃ correspondingly.

For thin films the quantities are determined by the following equations (see e.g. M. Borne, E. Wolf, The Principles of Optics.—Moscow: Nauka, 1970-855 p):

$$\begin{matrix}{B}_{1} ≅ \frac{r \frac{2}{12} ( {λ}_{1} ) + r \frac{2}{23} ( {λ}_{1} ) + 2 {r}_{12} ( {λ}_{1} ) {r}_{23} ( {λ}_{1} ) cos [ 2 β ( {λ}_{1} , d ) ]}{r \frac{2}{12} ( {λ}_{2} ) + r \frac{2}{23} ( {λ}_{2} ) + 2 {r}_{12} ( {λ}_{2} ) {r}_{23} ( {λ}_{2} ) cos [ 2 β ( {λ}_{2} , d ) ]} & ( 1 ) \\ {B}_{3} ≅ \frac{r \frac{2}{12} ( {λ}_{3} ) + r \frac{2}{23} ( {λ}_{3} ) + 2 {r}_{12} ( {λ}_{3} ) {r}_{23} ( {λ}_{3} ) cos [ 2 β ( {λ}_{3} , d ) ]}{r \frac{2}{12} ( {λ}_{2} ) + r \frac{2}{23} ( {λ}_{2} ) + 2 {r}_{12} ( {λ}_{2} ) {r}_{23} ( {λ}_{2} ) cos [ 2 β ( {λ}_{2} , d ) ]} & ( 2 ) \\ where \text{:} & \\ β ( λ , d ) = \frac{2 π d}{λ} {n}_{2} ( d ) \text{:} & \end{matrix}$$

r₁₂(λ), r₂₃(λ) is the reflection coefficients from boundaries “air-film” and “film-substrate” that depend on wavelength A and on refraction and reflection coefficients of mediums and do not depend on film thickness. The indices 1, 2 and 3 relate accordingly to air, film and substrate.

Theoretically, each of the equations (1) and (2) allows determination of film thickness d. However measurement result of the quantity B₁(or B₃) determines film thickness d, since the quantity d is a trigonometric function. If the quantity B (or B₃) is known, then the film thickness d can be determined from (1) or (2) only in a starting interval of the function cos [β(λ,d)], or in other words with the condition 2β(λ,d)≦π. This condition leads to the following limitation on the thickness of measuring films:

$$d \leq \frac{λ}{4 {n}_{2} ( λ )}$$

For example, with λ−1.43 mcm for oil quantity n₂(λ₂≈1.5), and then the limitations for thickness of measuring films is d≦0.24 mcm.

Therefore for the use of special measurement methods the value d can be determined only for the films with thickness of a few tenths of mcm.

With the use of three wavelengths λ₁, λ₂ and λ₃ that are close to each other, it is possible to increase the range of measuring quantities d.

By converting (1) and (2) and taking their difference and sum, the following can be obtained (with the condition that λ₁=λ₂−Δλ, λ₃=λ₂+Δλ₂, Δλ<<λ₂):

$$\begin{matrix}\frac{{B}_{3}}{{r}_{12} ( {λ}_{3} ) {r}_{23} ( {λ}_{3} )} - \frac{{B}_{1}}{{r}_{12} ( {λ}_{1} ) {r}_{23} ( {λ}_{1} )} ≅ \frac{{f}_{1} ( {λ}_{1} , {λ}_{3} ) + 4 sin [ 2 β ( {λ}_{2} , d ) ] sin [ \frac{4 π {dn}_{2} ( {λ}_{2} ) Δ λ}{{λ}_{2}^{2}} ]}{{r}_{12}^{2} ( {λ}_{2} ) + {r}_{23}^{2} ( {λ}_{2} ) + 2 {r}_{12} ( {λ}_{2} ) {r}_{23} ( {λ}_{2} ) cos [ 2 β ( {λ}_{2} , d ) ]} & ( 3 ) \\ \frac{{B}_{3}}{{r}_{12} ( {λ}_{3} ) {r}_{23} ( {λ}_{3} )} + \frac{{B}_{1}}{{r}_{12} ( {λ}_{1} ) {r}_{23} ( {λ}_{1} )} ≅ \frac{{f}_{2} ( {λ}_{1} , {λ}_{3} ) + 4 cos [ 2 β ( {λ}_{2} , d ) ] cos [ \frac{4 π {dn}_{2} ( {λ}_{2} ) Δ λ}{{λ}_{2}^{2}} ]}{{r}_{12}^{2} ( {λ}_{2} ) + {r}_{23}^{2} ( {λ}_{2} ) + 2 {r}_{12} ( {λ}_{2} ) {r}_{23} ( {λ}_{2} ) cos [ 2 β ( {λ}_{2} , d ) ]} & ( 4 ) \\ where & \\ {f}_{1 , 2} ( {λ}_{1} , {λ}_{3} ) ≅ \frac{{r}_{12}^{2} ( {λ}_{3} ) + {r}_{23}^{2} ( {λ}_{3} )}{{r}_{12} ( {λ}_{3} ) {r}_{23} ( {λ}_{3} )} ∓ \frac{{r}_{12}^{2} ( {λ}_{1} ) + {r}_{23}^{2} ( {λ}_{1} )}{{r}_{12} ( {λ}_{1} ) {r}_{23} ( {λ}_{1} )} . & \end{matrix}$$

Left parts of (3), (4) include data of measurements (B₁ and B₃) and optical constants (r₁₂(λ_{1,3}) and right parts of (3), (4) include optical constants and two groups of unknowns (since d is unknown) of trigonometric functions with argument 2β(λ₂,d) and trigonometric functions with arguments 4πdn₂(λ₂)Δλ/λ₂².

Since sines and cosines are expressed through each others therefore there are only 2 unknown functions, for example, cos [2β(λ₂,d)] and

$$sin [ \frac{4 π {dn}_{2} ( {λ}_{2} ) Δ λ}{{λ}_{2}^{2}} ] .$$

Therefore, the solving of 2 systems of equations (3), (4) allows to solve the problem of determination of 2 unknown:

$$cos [ 2 β ( {λ}_{2} , d ) ] \qquad and \qquad sin [ \frac{4 π {dn}_{2} ( {λ}_{2} ) Δ λ}{{λ}_{2}^{2}} ] .$$

With the determined quantity

$$sin [ \frac{4 π {dn}_{2} ( {λ}_{2} ) Δ λ}{{λ}_{2}^{2}} ]$$

it is possible to determine the thickness of film d in the interval of unambiquity of function

$$sin [ \frac{4 π {dn}_{2} ( {λ}_{2} ) Δ λ}{{λ}_{2}^{2}} ] .$$

The condition of unambiguity of the function

$$sin [ \frac{4 π {dn}_{2} ( {λ}_{2} ) Δ λ}{{λ}_{2}^{2}} ]$$

is equal to the condition

$$\frac{4 π {dn}_{2} ( {λ}_{2} ) Δ λ}{{λ}_{2}^{2}} \leq \frac{π}{2} or d \leq \frac{{λ}_{2}^{2}}{8 Δλ {n}_{2} ( {λ}_{2} )} .$$

For example with λ1.43 mcm for oil film the quantity n₂(λ₂)≈1.5 and for Δλ=0.1 mcm d≦1.6 mcm.

Therefore the proposed method allows to expand many times the range of measuring values of film thickness d, with the use of only 3 wavelengths that are located close to each other.

The proposed three-wave method with the use of three wavelengths λ₁,λ₂,λ₃ located close to each other to allow to determine the film thickness d based only by solving in the processing block (for example with a built-in special processor) of the system of non-linear equations (3) and (4), but also in a simpler way, directly from the measuring data with the use of a numerical algorithm for determination of d based on a search of a minimum of non-connection:
{[B₁−B(λ₁,λ₂,d)_{mod}]²+[B₃−B(λ₂,λ₃,d)_{mod}]²}^{1/2} (5)
Where
B₁, B₃ are the normalized quantities determined from measuring data at wavelengths λ₁,λ₂,λ₃ (see above);
B₁(λ₁,λ₂,d)_{mod}, B₃(λ₂,λ₃,d)_{mod} are the model values of corresponding quantities, depending on film thickness d (right parts of formulas (1), (2)).

FIG. 2 shows the results of mathematical modeling of operation of three-wave method of determination of thin oil film thickness. It shows dependence of determined (by numerical algorthym (5)) value of film d from the value of film thickness for d≦1.6 mcm given during modeling.

It will be understood that each of the elements described above, or two or more together, may also find a useful application in other types of methods and constructions differing from the type described above.

While the invention has been illustrated and described as embodied in a method of and device for thickness measurements of thin films, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of measuring a thickness of thin films, comprising the steps of irradiating a surface by an optical beam; receiving a reflected signal, analyzing a dependence of the reflected signal on a wavelength; determining a film thickness based on the analysis; and using for the irradiation three wavelengths which are close to each other, said determining including determining the film thickness based on the analysis of intensity of the reflected signal at the three wavelengths.

2. A method as defined in claim 1, wherein said using for the irradiation three wavelengths which are close to each other includes using the wavelength selected so that the three wavelengths are as follows:
λ₁=λ₂−Δλ,λ₃=λ₂+Δλ,Δλ<<λ₂.

3. A device for measuring a thickness of thin films, comprising means for irradiating a surface by an optical beam, means for receiving a reflected signal, means for analyzing a dependence of the reflected signal on a wavelength; means for determining a film thickness based on the analysis, wherein said means for irradiating a surface by an optical beam being configured so as to use for the irradiation three wavelengths which are close to each other, and said determining means being configured so that the film thickness is determined based on the analysis of intensity of the reflected signal at the three wavelengths.
